(19) United States
(12) Patent Application Publication
(10) Pub. No.: US 2016/0123063 A1
(43) Pub. Date: May 5, 2016

(54) MANUAL REGULATOR FOR DOOR GLASS OF VEHICLE

(71) Applicants: HYUNDAI MOTOR COMPANY, Seoul (KR); Kwangjin Co., Ltd., Asan-si (KR)

(72) Inventors: Hyun Woo LEE, Wanju-gun (KR); Sang Su LEE, Asan-si (KR)

(21) Appl. No.: 14/862,070

(22) Filed: Sep. 22, 2015

(30) Foreign Application Priority Data
Nov. 5, 2014 (KR) 10-2014-0152618

(51) Int. Cl. E05F 11/50; B60J 1/17

(52) U.S. Cl. CPC E05F 11/505; B60J 1/17

(57) ABSTRACT

The present disclosure provides a manual regulator device for a door glass of a vehicle for lifting and lowering operation of the door glass, adapted to prevent a phenomenon in which the door glass floats to be lifted or lowered by an external force. This is accomplished by an improved structure in which torque of a balance spring is transmitted to the clutch but not to a clutch spring.

### CROSS-REFERENCE TO RELATED APPLICATION

This application claims priority to under 35 U.S.C. §119(a) and the benefit of Korean Patent Application No. 10-2014 -0152618 filed Nov. 5, 2014, the entire contents of which are incorporated herein by reference.

### TECHNICAL FIELD

The present disclosure relates to a manual regulator device for a door glass of a vehicle. More particularly, the present disclosure relates to a manual regulator device for lifting and lowering operation of a door glass of a vehicle that is adapted to prevent a phenomenon in which a door glass floats to rise or fall by an external force.

### BACKGROUND

Typically, a power window regulator device as a kind of convenience device is installed inside a door panel of a vehicle, and the door glass is automatically lifted or lowered by the power window regulator device during a switch operation.

On the other hand, a manual regulator device adapted to be able to lift or lower the door glass by manually operating the handle by a passenger is applied to partial low-cost models of vehicles.

Referring to accompanying FIG. 11, a manual regulator device is configured to include a supporter 12 that supports a door glass 10, a roller 14 that is installed within the door panel to support a wire in a circulatable manner, a manual regulator 18 that is connected to the inside handle of the door to convey the wire 16 wound around the supporter 12 and the roller 14 in an opening or winding direction of the door glass.

Thus, when a passenger turns the inside handle of the door in an opening or closing direction, by cyclically moving the wire 16 from the manual regulator 18 in the opening or closing direction, the supporter 12 and the door glass 10 are lifted or lowered.

Here, the configuration and the flow of operation of a conventional manual regulator are described as follows.

Accompanying FIG. 1 is an exploded perspective view illustrating a conventional manual regulator device, FIG. 2 is a cross-sectional view of the conventional manual regulator device, and FIGS. 3 and 4 are a perspective view and a cross-sectional view illustrating an internal structure of the conventional manual regulator device.

In FIGS. 1 to 4, reference numeral 210 indicates a rotary shaft that is connected to the inside handle of the door.

An inner end of the rotary shaft 210 is connected to an operating handle for performing the lifting or lowering operation by a passenger, that is, an inside handle of door (not illustrated), and a drum 290, wound around by the wire, is connected to an outer end through a clutch 280.

At this time, between an inner end of the rotary shaft 210 and an outer end on which the drum 290 is installed, a balance spring 230 equipped in a balance spring housing 220, a balance spring fixing socket 240, a manual housing 250 installed on an outer surface of the balance spring housing 220, a clutch spring 260, a rotary shaft connector 270, and the clutch 280 are sequentially arranged.

The balance spring housing 220 surrounds a coil-shaped balance spring 230 and is fixedly installed on the door panel, and the balance spring fixing socket 240 is installed on the rotary shaft 210 in a simultaneously rotatable manner.

The balance spring 230 is equipped within the balance spring housing 220, and at the same time, its inner end is fixed to the outer diameter surface of the balance spring fixing socket 240. Compressive force of the balance spring 230 is directly transmitted to the rotary shaft 210 through the balance spring fixing socket 240.

The manual housing 250 is provided by a structure having a concave groove 252 in which the rotary shaft connector 270 and the clutch spring 260 are internally placed, and the manual housing 250 is installed on the outer surface of the balance spring housing 220.

Furthermore, the rotary shaft connector 270 is inserted into the concave groove 252 formed in a central portion of the outer surface of the manual housing 250 and is simultaneously connected to the rotary shaft 210 in a simultaneously rotatable manner.

At this time, an incision surface 272 for providing the contact between the clutch 280 and the clutch spring 260 is formed in a circumferentially partial section from the outer diameter surface of the rotary shaft connector 270.

The clutch spring 260 is provided by a structure in which it is formed by a coil type of being wound several times, and at the same time, clutch contact ends 262 bent inward are formed at both ends of the clutch spring 260.

The clutch spring 260 provided in this way is inserted between the inner diameter surface of the concave groove 252 of the manual housing 250 and the outer diameter surface of the rotary shaft connector 270 so as to be expandable and contractible in the radial direction.

The clutch 280 includes a body portion 282 connected to an outer end of the rotary shaft 210, a fastening end 286 that is formed to protrude integrally from the outer diameter portion of the body portion 282 toward the outside direction and is fastened to the drum 290, and a spring operation end 284 that is formed to protrude integrally from the outer diameter portion of the body portion 282 toward the inside direction and is arranged so as to be able to come into contact with a clutch contact end 262 of the clutch spring 260 through the incision surface 272 of the rotary shaft connector 270.

Here, the flow of operation of the conventional manual regulator device having the above-mentioned structure will be described as follows.

The accompanying FIG. 5 is a cross-sectional view illustrating an operation of expansion and contraction of the clutch spring of the conventional manual regulator device.

As described above, the compressive force of the balance spring 230 is directly transmitted to the rotary shaft 210 through the balance spring fixing socket 240, and the balance spring 230 enters a state of always transmitting torque to the clutch spring 260.

First, when the passenger turns the inside operating handle of the door to raise or lower the door glass, the rotary shaft 210 connected to the operating handle rotates.

At this time, the passenger is able to easily turn the operating handle with smaller force by the compressive force of the balance spring 230 acting on the rotary shaft 210.

At the same time as the rotation of the rotary shaft 210, the rotary shaft connector 270 installed on the rotary shaft 210 rotates in the lifting or lowering direction of the door glass (solid arrow of FIG. 5), and since the incision surface 272 of the shaft connector 270 enters a state of being caught by the clutch contact end 262 of the clutch spring 260, the clutch spring 260 and the rotary shaft connector 270 also rotate together.

In addition, the clutch 280, in which its spring operation end 284 is inserted into the incision surface 272 of the rotary shaft connector 270, also rotates together with the clutch spring 260.

Subsequently, since the fastening end 286 of the clutch 280 and the outer end of the rotary shaft of 210 are in the state of being connected to the drum 290, the drum 290 rotates, the wire 16 (refer to FIG. 11) wound around the drum 290 is cyclically moved in the opening or closing direction, and thus, the normal lifting or lowering operation of the door glass 10 is performed.

Thus, at the time of normal lifting and lower of the door glass, the rotary shaft 210, the clutch spring 260 and the clutch 280 rotate simultaneously. At this time, compressive force of the balance spring 230 is directly transmitted to the rotary shaft 210 via the balance spring fixing sockets 240, and the balance spring 230 enters a state of transmitting the rotational torque to the clutch spring 260 and the clutch 280. Accordingly, the rotational torque of the rotary shaft 210 is easily transmitted to the drum 290 coupled to the clutch 280 through the gear mountain, which leads to the normal lifting or lowering of the door glass 10.

On the other hand, unlike the normal lifting and lowering operations of the door glass as described above, when floating or shock (in particular, vertical floating or shock) is applied to the door glass, the drum 290 can rotate through the wire, and the rotational force of the drum 290 is transmitted to the clutch 280.

At this time, before the rotational force of the clutch 280 is transmitted to the rotary shaft connector 270, the clutch spring 260 is expanded in the outer diameter direction during rotation of the clutch 280.

In other words, since the spring operation end 284 of the clutch 280 comes into contact with the clutch contact end 262 of the clutch spring 260 to push the clutch contact end 262 in the outer diameter direction during rotation of the clutch 280, the clutch spring 260 enters a state of being inserted between the inner diameter surface of the concave groove 252 of the manual housing 250 and the outer diameter surface of the rotary shaft connector 270, while being expanded in the outer diameter direction.

Accordingly, the clutch spring 260 enters a state of coming into friction-contact with the inner diameter surface of the concave groove 252 of the manual housing 250 and being constrained, while being expanded in the outer diameter direction.

Thus, the clutch spring 260 stops, and at the same time, the rotary shaft connector 270 enters a state of not being rotated, and the rotary shaft 210 connected to the rotary shaft connector 270 also maintains a stationary state.

Eventually, even if floating or shock is applied to the door glass, since the clutch spring 260 enters the state of being constrained while being expanding in the outer diameter direction, it is possible to prevent the phenomenon in which the door glass 10 is lifted or lowered.

However, the conventional manual regulator device described above has the following problems.

Compressive force of the balance spring 230 is directly transmitted to the rotary shaft 210 through the balance spring fixing socket 240, and thus, the balance spring 230 enters the state of always transmitting the torque to the clutch spring 260 in the direction opposite to the expansion.

Accordingly, although the clutch spring 260 needs to be expanded in the outer diameter direction along with floating or shock being applied to the door glass 260, since the balance spring 230 always transmits torque to the clutch spring 260 in the direction opposite to the expansion, a phenomenon occurs in which the clutch spring 260 fails to be easily expanded in the outer diameter direction.

In other words, as the clutch spring 260 fails to be completely expanded and is incompletely expanded, a phenomenon occurs in which it fails to be firmly inserted between the inner diameter surface of the concave groove 252 of the manual housing 250 and the outer diameter surface of the rotary shaft connector 270.

Consequently, there is a problem in which the clutch spring 260 fails to be constrained, and the rotational force is transmitted to the rotary shaft 210 from the drum 290 along with the floating or shock being applied to the door glass, leading to lifting or lowering of the door glass without operation of the operating handle by a passenger.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

An object of the present invention is to provide a manual regulator device for a door glass of a vehicle that is adapted to easily prevent a phenomenon in which the door glass is lifted or lowered without operation of the operating handle by a passenger due to a floating phenomenon of the door glass, by an improved structure in which torque of the balance spring is transmitted to the clutch but not to the clutch spring, unlike the conventional manual regulator.

In one aspect, the present invention provides a manual regulator device for a door glass of a vehicle which is configured to include a rotary shaft connected to an inside operating handle of door; a rotary shaft connector which is formed integrally with an outer diameter portion of the rotary shaft, and in which an incision groove for clutch connection is formed in a partial section of an outer diameter surface of the rotary shaft connector; a clutch spring disposed on an outer diameter surface of the rotary shaft connector in a simultaneously rotatable manner; a clutch coupled to the rotary shaft connector and the clutch spring in a simultaneously rotatable manner; a balance spring which is directly connected to the clutch to transmit torque to the clutch spring in an expansion direction; a manual housing on an inner surface of a balance spring housing to protect the balance spring, and having a concave groove in which the rotary shaft connector and the clutch spring are internally positioned; and a wire conveying drum which is coupled to an outer end of the clutch in a simultaneously rotatable manner.

Preferably, the clutch spring is of a coil type being wound several times and provided by a structure in which clutch contact ends bent inward are formed at both ends of the clutch spring.

More preferably, a spring operation end is integrally formed on the inner surface of the clutch spring, the spring operation end being inserted into a clutch connecting incision groove of the rotary shaft connector so as to be able to come into contact with the clutch contact ends of the clutch spring.

In particular, the clutch spring is between an inner diameter surface of the concave groove of the manual housing and the outer diameter surface of the rotary shaft connector in a radially expandable and contractible manner.

Also, the outer diameter surface of the clutch has a spring fixing groove to which an inner end of the balance spring is inserted and fastened.

Also, a spline for spline coupling with the inner diameter surface of the drum is integrally formed on the outer surface of the clutch.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exploded perspective view of a conventional manual regulator device;

FIG. 2 is a cross-sectional view of the conventional manual regulator device;

FIGS. 3 and 4 are a perspective view and a cross-sectional view illustrating an internal structure of the conventional manual regulator device;

FIG. 5 is a cross-sectional view illustrating operations of expansion and contraction of a clutch spring of the conventional manual regulator device;

FIG. 6 is exploded perspective view illustrating a manual regulator device according to the present invention;

FIG. 7 is a cross-sectional view illustrating the manual regulator device according to the present invention;

FIG. 8 is a perspective view illustrating a coupling relation among a manual shaft, a clutch and a balance spring of the manual regulator device according to the present invention;

FIG. 9 is a perspective view illustrating a power transmission relation of the manual regulator device according to the present invention;

FIG. 10 is a cross-sectional view illustrating a power transmission direction during normal operation and a power transmission direction during external force action of the manual regulator device according to the present invention; and

FIG. 11 is a schematic view for illustrating an installation position and its operational flow of the manual regulator device.

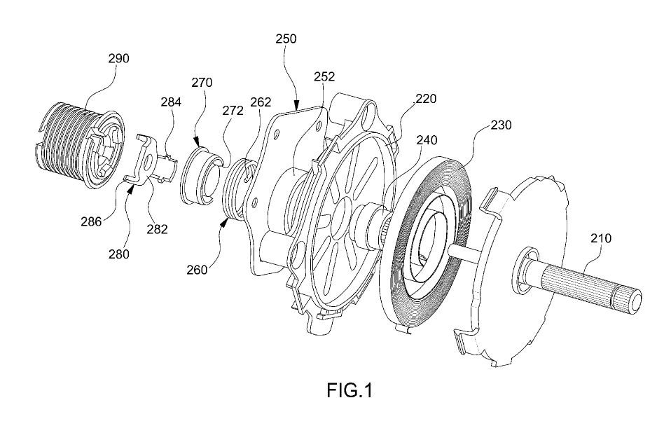

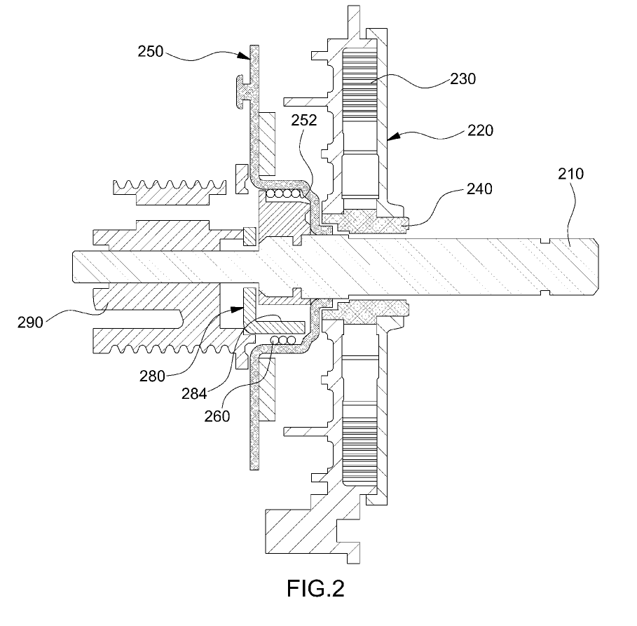

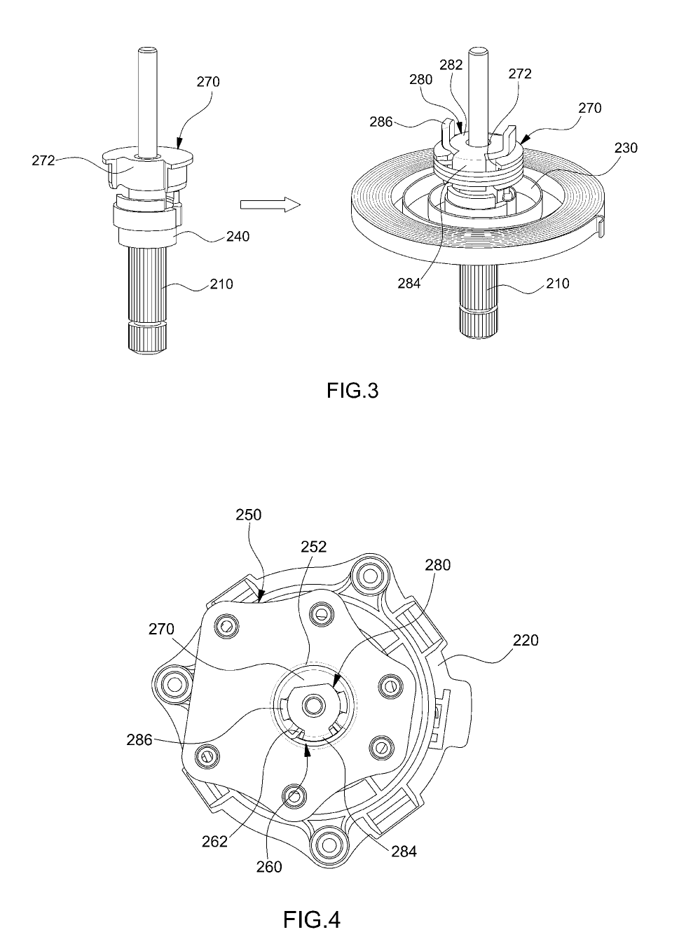

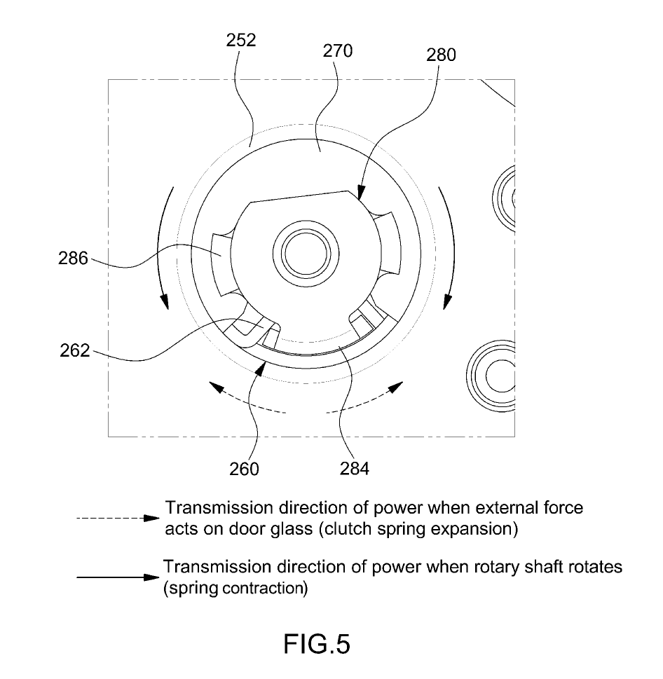

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, a preferred embodiment of the present invention will be described in detail with reference to the accompanying drawings.

The present invention is to provide a manual regulator device that is adapted to be able to easily prevent a phenomenon in which the door glass is lifted and lowered without operations of the operating handle by a passenger due to a floating phenomenon of the door glass.

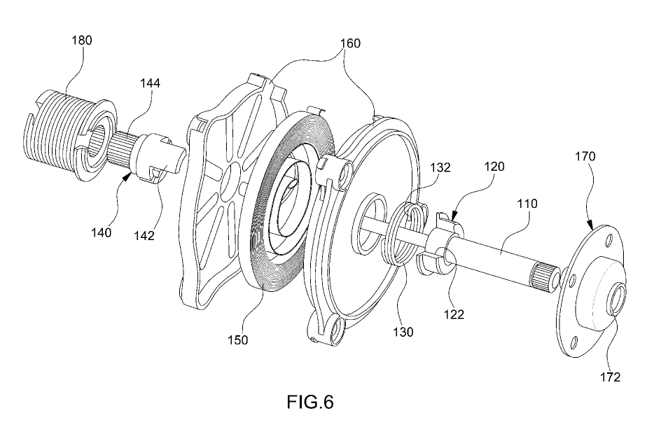

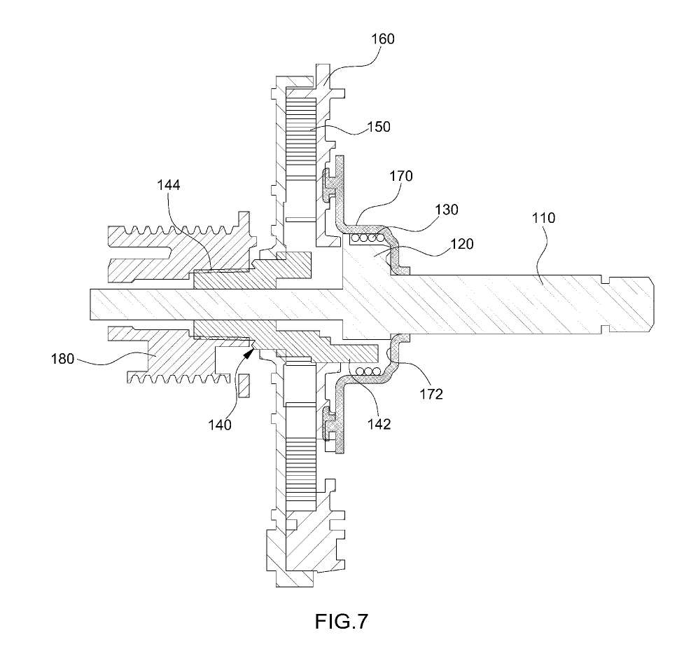

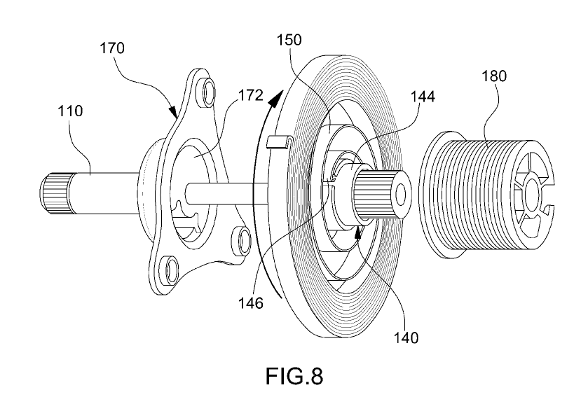

Accompanying FIG. 6 is an exploded perspective view illustrating a manual regulator device according to the present invention, FIG. 7 is a cross-sectional view illustrating the manual regulator device according to the present invention, and FIG. 8 is a perspective view illustrating a coupling relation among a manual shaft, a clutch and a balance spring of the manual regulator device according to the present invention.

In FIGS. 6 to 8, reference numeral 110 indicates a rotary shaft that is connected to an inside operating handle of the door.

An inner end of the rotary shaft 110 is connected to the operating handle for performing the lifting and lowering operations of the door glass by a passenger, that is, an inside handle of door (not illustrated), and a wire conveying drum 180, around which the wire is wound, is connected to an outer end via the clutch 140.

At this time, a rotary shaft connector 120 is integrally formed on an intermediate portion outer diameter surface of the rotary shaft 110 in a simultaneously rotatable manner.

The rotary shaft connector 120 is formed to have a larger diameter than the rotary shaft 110, and in a partial section of the outer diameter surface in the circumferential direction, a clutch connecting incision groove 122 for connection to the clutch is formed.

In addition, a clutch spring 130 is wound around the outer diameter surface of the rotary shaft connector 120 in a simultaneously rotatable manner.

The clutch spring 130 is a coil type of being wound several times, and clutch contact ends 132, which are bent inward and arranged in the clutch connecting incision groove 122, are formed at the both ends of the clutch spring 130.

Here, the clutch 140 is coupled to the rotary shaft connector 120 and the clutch spring 130 in a simultaneously rotatable manner.

To this end, a spring operation end 142 is formed to integrally protrude from the inner surface of the clutch 140, and the spring operation end 142 enters a state in which it is inserted into the clutch connecting incision groove 122 of the rotary shaft connector 120 and is arranged so as to come into contact with the clutch contact end 132 of the clutch spring 130.

In particular, a balance spring 150 is directly connected to the outer diameter surface of the clutch 140.

In other words, the inner end of the balance spring 150 is inserted and fastened to an spring fixing groove 146 formed on the outer diameter surface of the clutch 140, and thus the balance spring 150 is directly connected to the clutch 140.

Thus, as the balance spring 150 is directly connected to the clutch 140, after the rotational torque of the balance spring 150 is directly transmitted to the clutch 140, the rotational torque is indirectly transmitted to the clutch spring 130 through the clutch 140.

At this time, the rotational torque of the balance spring 150 is always transmitted to the clutch spring 130 through the clutch 140 as a torque for expanding the clutch spring 130 in the radial direction.

In other words, unlike the prior art in which the balance spring always transmits the torque to the clutch spring in the direction opposite to the expansion, in the present invention, as the balance spring 150 is directly connected to the clutch 140, the balance spring 150 always transmits the torque to the clutch spring 130 in the expansion direction.

Meanwhile, the balance spring 150 is equipped within a balance spring housing 160 fixedly installed on a door pane (not illustrated), and a manual housing 170 is assembled on the inner surface of the balance spring housing 160.

The manual housing 170 is provided by the structure having a concave groove 172 that opens towards the clutch 140, and the rotary shaft connector 120 and the clutch spring 130 are internally placed within the concave groove 172.

Of course, the spring operation end 142 of the clutch 140 also extends into the concave groove 172 and is simultaneously inserted into the clutch connecting incision groove 122 of the rotary shaft connector 120. Thus, the spring operation end 142 is arranged so as to be able to come into contact with the clutch contact end 132 of the clutch spring 130.

In this way, as the clutch spring 130 is internally placed within the concave groove 172 of the manual housing 170, the clutch spring 130 is disposed between the inner diameter surface of the concave groove 172 of the manual housing 170 and the outer diameter surface of the rotary shaft connector 120 in a radially expandable manner.

On the other hand, a spline 144 for spline coupling to the inner diameter surface of the wire conveying drum 180 is integrally formed on the outer surface of the clutch 140, and therefore, the clutch 140 and the wire conveying drum 180 are connected to each other by the spline 144 in a simultaneously rotatable manner.

Here, the flow of operation of the manual regulator device for door glass of the present invention having the above-mentioned structure will be described as follows.

During Normal Operation

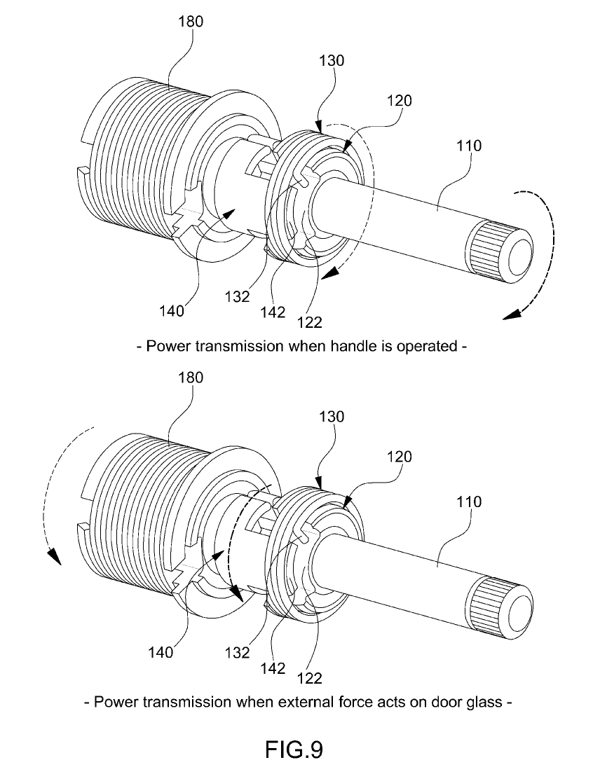

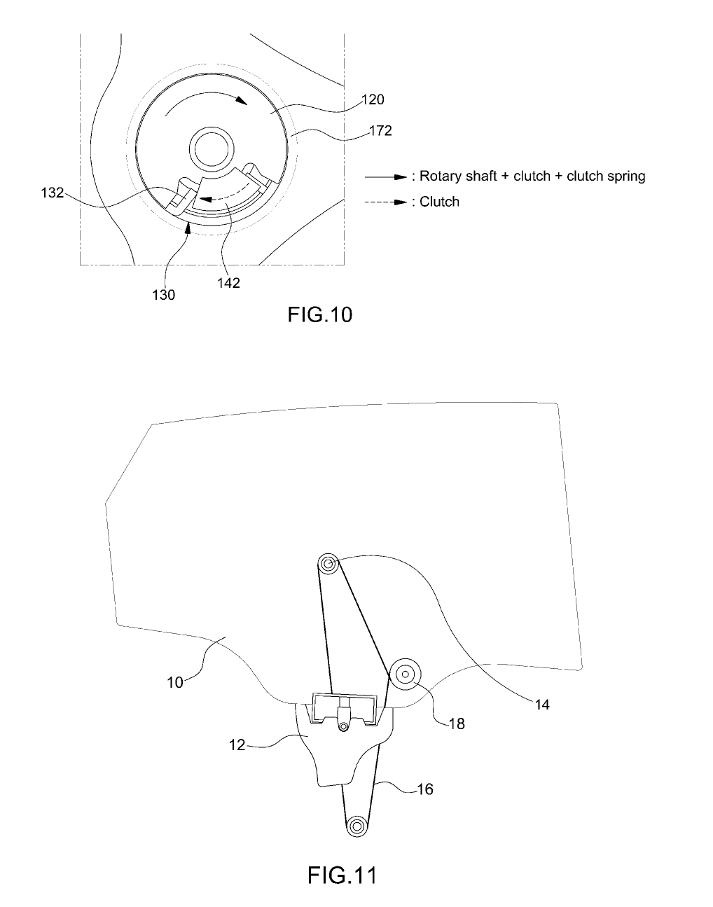

An upper diagram of the accompanying FIG. 9 illustrates the flow of power transmission for normally lifting or lowering the door glass when the operating handle is operated, and FIG. 10 is a cross-sectional view illustrating a power transmission direction during the normal operation.

First, when the passenger turns the inside operating handle of the door for lifting or lowering the door glass, the rotary shaft 110 connected to the operating handle rotates in the lifting or lowering direction of the door glass, and the rotary shaft connector 120 integrally connected to the rotary shaft 110 rotates.

In addition, since there is a state in which the spring operation end 142 of the clutch 140 is constrained and inserted to the clutch connecting incision groove 122 of the rotary shaft connector 120, when the rotary shaft connector 120 rotates, the clutch 140 also rotates in the same direction together.

In addition, since there is a state in which the clutch contact end 132 of the clutch spring 130 is also inserted into the clutch connecting incision groove 122 of the rotary shaft connector 120, the clutch spring 130 also rotates in the same direction when the rotary shaft connector 120 rotates.

In this way, when the operating handle is operated to normally lift or lower the door glass, as indicated by the solid arrows in accompanying FIG. 10, the rotary shaft 110, the clutch 140, and the clutch spring 130 simultaneously rotate.

Subsequently, the wire conveying drum 180 coupled to the spline 144 of the clutch 140 also rotates together with the clutch 140.

Therefore, as the wire wound around the wire conveying drum 180 is circularly moved in the opening or closing direction, the normal lifting or lowering operation of the door glass is made.

When External Force Acts On Door Glass

A bottom diagram of accompanying FIG. 9 illustrates the flow of power transmission when an external force acts on the door glass, and FIG. 10 is a cross-sectional view illustrating a power transmission direction when the external force acts.

Unlike the normal lifting or lowering operation of the door glass as described above, when floating or shock (in particular, vertical floating or shock) is applied to the door glass, the wire conveying drum 180 can rotate through the wire, and the rotational force of the drum 180 is transmitted to the clutch 140.

At this time, as the balance spring 150 is directly connected to the clutch 140, the balance spring 150 enters a state of always transmitting the torque to the clutch spring 130 in the expansion direction.

Subsequently, when the clutch 140 rotates, the spring operation end 142 of the clutch 140 presses the clutch contact end 132 of the clutch spring 130, and the windings of the spring 130 expand while spreading to the outside.

Subsequently, since the clutch spring 130 is in a state of being placed between the inner diameter surface of the concave groove 172 of the manual housing 170 and the outer diameter surface of the rotary shaft connector 120, the clutch spring 130 enters a state of expanding and simultaneously coming into friction-contact with the inner diameter surface of the good groove 172 and being constrained.

Therefore, since the clutch spring 130 enters a non-rotatable locking state, the rotary shaft connector 120 and the rotary shaft 110 also enter a state of not being rotated, and eventually it is possible to prevent a phenomenon in which the door glass is lifted or lowered even if floating or shock is applied to the door glass.

Through the above-mentioned means for solving the problems, the present invention provides the following effects.

First, by preventing the torque of the balance spring from being directly transferred to the clutch spring, it is possible to easily prevent the phenomenon in which the door glass is lifted and lowered without operations of the operating handle by a passenger due to a floating phenomenon of the door glass.

Second, it is possible to reduce the number of parts and at the same time to achieve the structural simplification as compared to the existing regulator device, and it is possible to reduce the manufacturing costs accordingly.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A manual regulator device for a door glass of a vehicle comprising:
a rotary shaft connected to an inside operating handle of a door;
a rotary shaft connector which is formed integrally with an outer diameter portion of the rotary shaft and in which an incision groove for clutch connection is formed in a partial section of an outer diameter surface of the rotary shaft connector;
a clutch spring which is disposed on an outer diameter surface of the rotary shaft connector in a simultaneously rotatable manner;
a clutch which is coupled to the rotary shaft connector and the clutch spring in a simultaneously rotatable manner;
a balance spring which is directly connected to the clutch to transmit torque to the clutch spring in an expansion direction;
a manual housing on an inner surface of a balance spring housing to protect the balance spring, and having a concave groove in which the rotary shaft connector and the clutch spring are internally positioned; and
a wire conveying drum which is coupled to an outer end of the clutch in a simultaneously rotatable manner.

2. The manual regulator device of claim 1, wherein the clutch spring is of a coil type being wound several times and provided by a structure in which clutch contact ends bent inward are formed at both ends of the clutch spring.

3. The manual regulator device of claim 2, wherein a spring operation end is integrally formed on the inner surface of the clutch spring, the spring operation end being inserted into a clutch connecting incision groove of the rotary shaft connector so as to be able to come into contact with the clutch contact ends of the clutch spring.

4. The manual regulator device of claim 1, wherein the clutch spring is between an inner diameter surface of the concave groove of the manual housing and the outer diameter surface of the rotary shaft connector in a radially expandable manner.

5. The manual regulator device of claim 1, wherein the outer diameter surface of the clutch has a spring fixing groove to which an inner end of the balance spring is inserted and fastened.

6. The manual regulator device of claim 1, wherein a spline for spline coupling with the inner diameter surface of the drum is integrally formed on the outer surface of the clutch.
